(19) United States
(12) Patent Application Publication
(10) Pub. No.: US 2002/0161911 A1
(43) Pub. Date: Oct. 31, 2002

(54) Systems and methods for efficient memory allocation for streaming of multimedia files

(76) Inventors: Thomas Pinckney III, Cambridge, MA (US); Garry Kenneth Kessler, Westboro, MA (US); Christopher Angelo Provenzano, Somerville, MA (US); Benjamin Joseph Thomas III, Bedford, MA (US)

Correspondence Address: ROPES & GRAY, ONE INTERNATIONAL PLACE, BOSTON, MA, 02110-2624, US

(21) Appl. No.: 10/126,460

(22) Filed: Apr. 19, 2002

Related U.S. Application Data
(60) Provisional application No. 60/284,973, filed on Apr. 19, 2001.
(60) Provisional application No. 60/289,409, filed on May 8, 2001.

(51) Int. Cl. G06F 15/16

(52) U.S. Cl. 709/231

(57) ABSTRACT

Systems and methods for streaming of multimedia files over a network are described. A streaming delivery accelerator (SDA) receives content from a content provider, caches at least part of the content, forming a cache file, and streams the cache file to a user. The described systems and methods are directed to separate (shred) the content into contiguous cache files suitable for streaming. The shredded cache files may have different transmission bit rates and/or different content, such as audio, text, etc. Checksums can migrate from the content file to the shredded cache files and between different network protocols without the need for recomputing the checksums.

### CROSS-REFERENCE TO OTHER PATENT APPLICATIONS

This application claims the benefit of U.S. provisional applications No. 60/284,973, filed Apr. 19, 2001, and No. 60/289,409, filed May 8, 2001, the entire disclosures of which are incorporated herein by reference.

### FIELD OF THE INVENTION

The invention is directed to real-time streaming of multimedia files. More particularly, the invention is directed to a method for efficiently allocating memory for file streaming and to a Streaming Delivery Accelerator (SDA) with persistent and buffer memory adapted to efficiently store and stream multimedia files for playback to an end-user over a network.

### BACKGROUND OF THE INVENTION

The Internet has witnessed a rapid growth in the deployment of Web-based streaming applications during recent years. In these applications, congestion control and quality adaptation is paramount so as to match the stream quality delivered to an end-user to the average available bandwidth. In other words, the delivered quality is limited by the bottleneck bandwidth on the path to the end-user. Moreover, there is a need for scalability as the number of people accessing multimedia services over the Internet grows, which is further exacerbated by the rapidly increasing demand for bandwidth-intensive video and audio streaming services. Adding more bandwidth and Quality-of-Service (QoS) support to the Internet is one potential remedy for performance problems, but large scale deployment is costly and may take a long time. More recently, content providers have began to offer solutions encompassing technologies such as caching, enhanced routing and load balancing. These solutions do not require any specific support from the network, but provide the end-user with an improved experience to due the enhanced network efficiency.

However, there is still a need for improvement of delivery of streaming multimedia files over a network, in particular over the Internet, and more particularly for a system and method that can efficiently deliver both scheduled and on-demand streamed content to an end-user over variable bandwidth connections.

### SUMMARY OF THE INVENTION

The invention is directed to efficiently storing cached content in a network appliance, such as a Streaming Delivery Accelerator (SDA), and streaming the cached content to a user requesting the content. In one embodiment, the SDA includes a persistent memory device, such as a disk, and at least two volatile buffer memory devices which cooperate to provide a contiguous and uninterrupted data stream of the content to the user. The first buffer memory caches content from disk for streaming. A second buffer memory starts caching content from the disk memory before the first buffer memory finishes streaming content to the user. Thereafter, the roles of the first and second buffer are reversed. The SDA can thereby continuously stream the content by fetching content from the second buffer when the first buffer is empty and vice versa. This can prevent an interruption of the bit stream to the user due to disk seeks.

According to one aspect of the invention, a method of allocating data blocks for streaming a file includes determining a data transfer characteristic for streaming the file, allocating data blocks having a block size on a persistent storage medium, wherein the block size is related to the data transfer characteristic, and storing the file in form of the data blocks on the persistent storage medium. The method further includes transferring the data blocks from the persistent storage medium into a first buffer memory, wherein the size of the data blocks in the first buffer memory is identical or substantially identical to the block size, and based on an actual or measured bit rate determined for the stream to a user, allocating a second buffer memory to receive from the persistent storage medium additional data blocks based on the actual bit rate to a user, wherein the size of the data blocks in the second buffer memory is also identical to the block size. The additional data blocks are then transmitted from the persistent storage medium to the second buffer memory when an estimated transmit time for streaming a portion of the data blocks remaining in the first buffer to the user is approximately equal to a time required to transfer the additional data blocks from the persistent storage medium into the second buffer.

According to another aspect of the invention, a device for allocating data blocks for streaming a file includes a persistent storage medium storing the data blocks of the file, wherein the data blocks have a block size allocated related to a data transfer characteristic. The device further includes a first buffer memory that receives the data blocks from the persistent storage medium, wherein the size of the data blocks in the first buffer memory is identical to the block size, and a second buffer memory that receives additional data blocks from the persistent storage medium, wherein the size of the data blocks in the second buffer memory is also identical to the block size. The additional data are received in the second buffer memory when an estimated transmit time for streaming a portion of the data blocks remaining in the first buffer to the user is approximately equal to a time required to transfer the additional data blocks from the persistent storage medium into the second buffer.

According to yet another aspect of the invention, a streaming delivery accelerator (SDA) for efficiently streaming a file, for example over a network, includes at least one input channel that receives a content file from a content provider, at least one output channel with a predetermined streaming characteristic for streaming a cache file to a user and a persistent storage medium that caches data blocks of the content file and stores the data blocks as the cache file, said data blocks having a block size allocated related to a data transfer characteristic. The SDA further includes a first buffer memory that receives the data blocks from the persistent storage medium, said data blocks in the first buffer memory having the same block size as in the persistent storage medium, and a second buffer memory that receives additional data blocks from the persistent storage medium, said data blocks in the second buffer memory also having the same block size as the block size as in the persistent storage medium. The additional data are received in the second buffer memory when an estimated transmit time for streaming a portion of the data blocks remaining in the first buffer to the user is approximately equal to a time required to transfer the additional data blocks from the persistent storage medium into the second buffer.

Embodiments of the invention can include one or more of the following features. The SDA can store files of different streaming bit rates, so that the transfer characteristic can be a maximum bit rate for the file. The persistent storage medium can be a disk storage medium, such as a magnetic, optic or magneto-optic disk medium, whereas the first buffer memory and the second buffer memory are volatile memory devices, such as random access memory (RAM).

The blocks can have different block sizes, which can be determined by a maximum streaming rate of the file, which can be greater than the streaming (bit) rate to the user, and/or a maximum seek time for the data blocks on the disk storage medium. The blocks and/or block sizes can be organized in an inode structure, wherein the blocks have at least two block types. A first block type is associated with a direct block which includes the data blocks and a second block type with an indirect block that has a pointer to a other direct blocks or of additional indirect blocks. The block size of the additional direct blocks can be greater than the block size of the indirect blocks and the blocks of the first block type. The persistent storage medium stores at least the direct blocks as a contiguous sequence of blocks.

The at least one input channel can operate using a first network protocol, and the at least one output channel operates using a second network protocol that can be identical to or different from the first network protocol. The cache file can be stored in the persistent medium device as a protocol-independent canonical file. The data blocks of the stored cache file can include checksum representative of payload data, which obviates the need to recomputed the checksums each time the file is streamed. In most cases, checksums of packets of the streamed file may be computed by simply adding the stored checksums or portions thereof.

In another aspect the invention may be understood to provide computer-readable medium having instructions stored thereon directing a computer system to implement the processes or portions of the processes described above.

Further features and advantages of the present invention will be apparent from the following description of preferred embodiments and from the claims.

### BRIEF DESCRIPTION OF THE DRAWINGS

The following figures depict certain illustrative embodiments of the invention in which like reference numerals refer to like elements. These depicted embodiments are to be understood as illustrative of the invention and not as limiting in any way.

FIG. 1 depicts a prior art system for streaming content over a network;

FIG. 2 depicts a system for streaming content over a network with a streaming delivery accelerator (SDA) and content and network management;

FIG. 3 is a schematic block diagram of an SDA cache architecture;

FIG. 4 is a flow diagram depicting a process for caching using a quality metric;

FIG. 5 schematically depicts a cache fill process;

FIG. 6 is a flow diagram depicting an initial cache fill process;

FIG. 7 is a flow diagram depicting a process for caching additional content;

FIG. 8 shows schematically a cache filling and eviction process;

FIG. 9 shows schematically “shredding” of a source content file;

FIG. 10 is a schematic diagram of files subject to different cache eviction policies; and

FIG. 11 depicts disk storage with variable size file allocation units.

### DETAILED DESCRIPTION OF CERTAIN ILLUSTRATED EMBODIMENTS

The invention is directed to efficiently transmitting streamed content, such as multimedia files containing video and audio, from a content provider to an end-user over a network. The end-user can be an individual subscriber and/or an enterprise, where several clients are connected, for example, via an Intranet, LAN or WAN. More particularly, the invention is directed to a streaming delivery accelerator (SDA) that acts as a proxy cache and includes a persistent memory, such as a disk memory, and at least two buffer memories. After a first buffer has cached content from the disk, a second buffer memory starts caching content from the disk memory before a first buffer memory finishes streaming content to the user. The roles of the first and second buffer are then reversed. The SDA can thereby continuously stream the content by fetching content from the second buffer when the first buffer is empty. This can prevent an interruption of the bit stream to the user due to disk seeks.

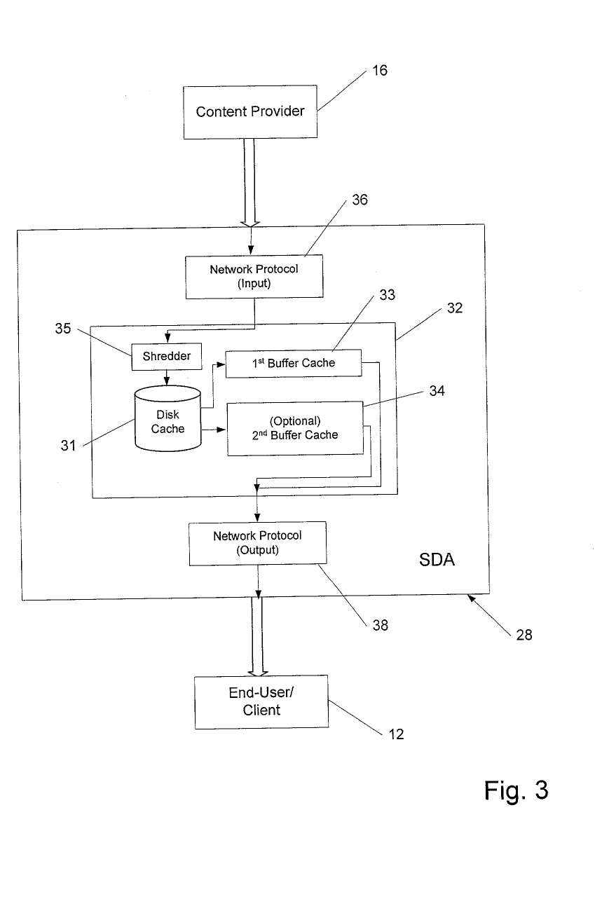

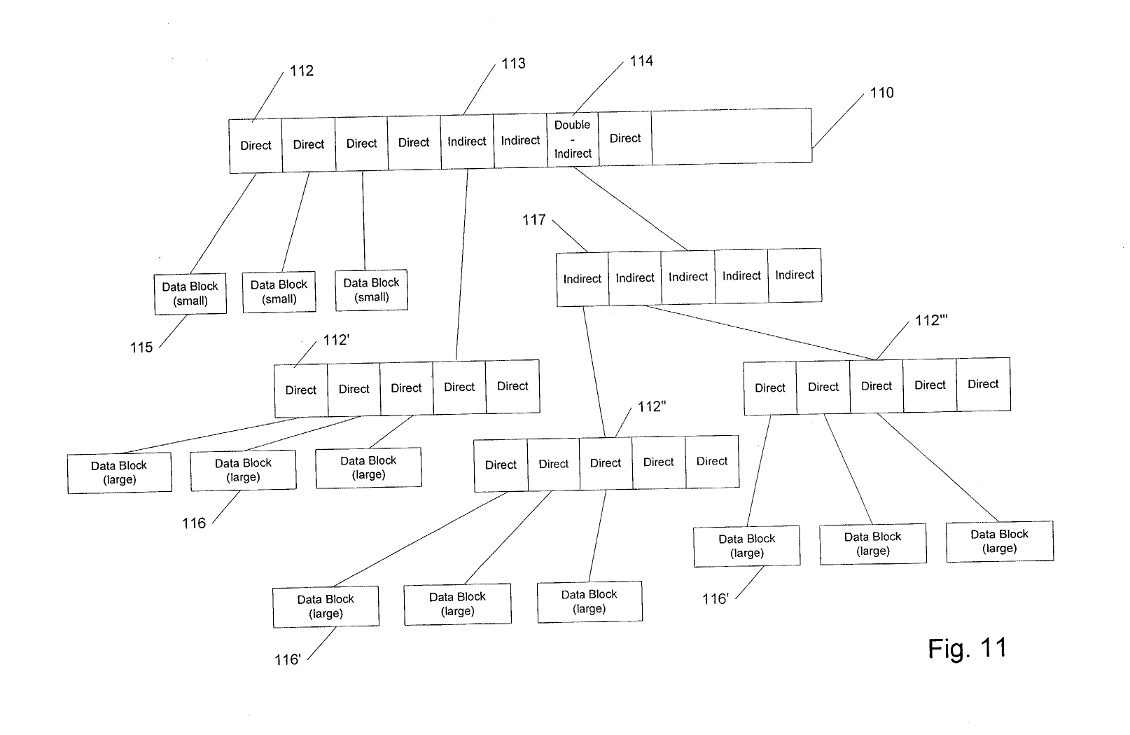

The organization of the SDA and in particular the memory is described below with reference to FIG. 3. FIG. 11 illustrates schematically the organization of the persistent memory, for example the disk cache depicted in FIG. 3, which is organized in form of an inode structure known, for example, from the UNIX operating system. As will be described in detail below, the size of the data blocks in the volatile memory is preferably identical , or substantially identical, to the size of the file allocation units in the persistent memory.

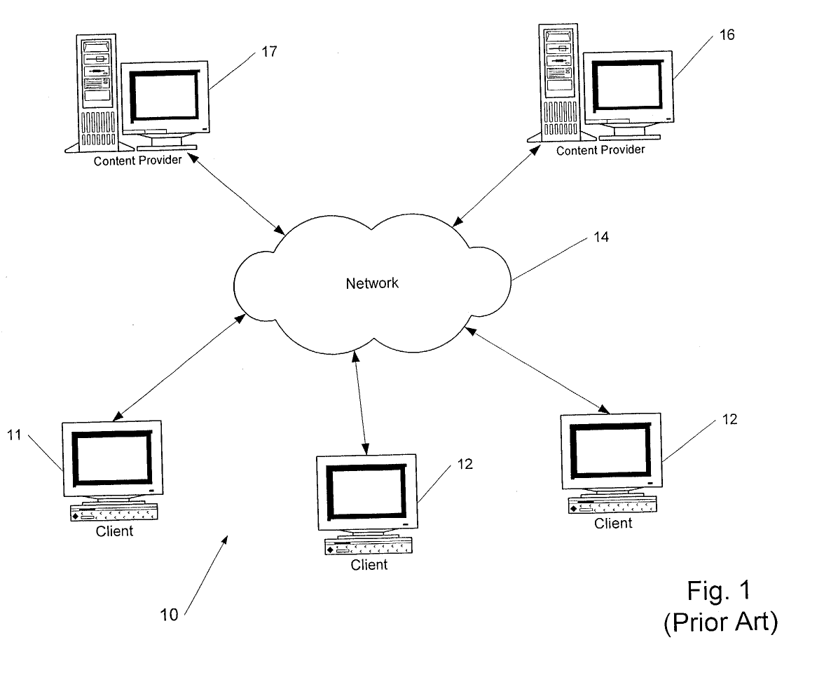

Before describing the invention in detail, reference is made first to FIG. 1 to provide some background information. A conventional system 10 includes content provider servers 16, 17 providing content to end-users or client system 11, 12, with the servers 16, 17 being connected to the client system 12 through a network 14, such as the Internet or a LAN, which can support different connections, such as a telephone modem, IDSN, ATM, LAN, WAN, Ethernet, T1/T3, Frame Relay, Sonet, etc. To obtain content from a content provider 16, a client 12 will typically open a browser window and establish a connection to the content provider 16, for example, by clicking in the window on a link or http address. The content provider 16 can then transmit the content directly to the client 12.

In the depicted system 10, the client system 11, 12 can be any suitable computer system such as a PC workstation, a handheld computing device, a wireless communication device, or any other such device, equipped with a network client capable of accessing a network server and interacting with server 16, 17 to exchange content with the servers 16, 17. The network client may be a web client, such as a web browser that can include the Netscape web browser, the Microsoft Internet explorer web browser, the Lynx web browser, or a proprietary web browser, or web client that allows the user to request and receive streaming content from the network server. The communication path between the clients 11, 12 and the servers 16, 17 can be an unsecured communication path, such as the Internet 14, or a secure communication path, for example, the Netscape secured socket layer (SSL) security mechanism that provides to a remote user a trusted path between a conventional web browser program and a web server.

This approach has several drawbacks. For example, separate communication channels need to be opened to connect several clients 12 to the content provider 16, even if the clients 12 request the same content. The content provider 16 may be at a distant location from the clients 12, so that the replication of connections would require excessive bandwidth, which can introduce latency and network congestion. Accordingly, these bottlenecks should be “smoothed” out, which is one of the tasks performed by the SDA described in detail below.

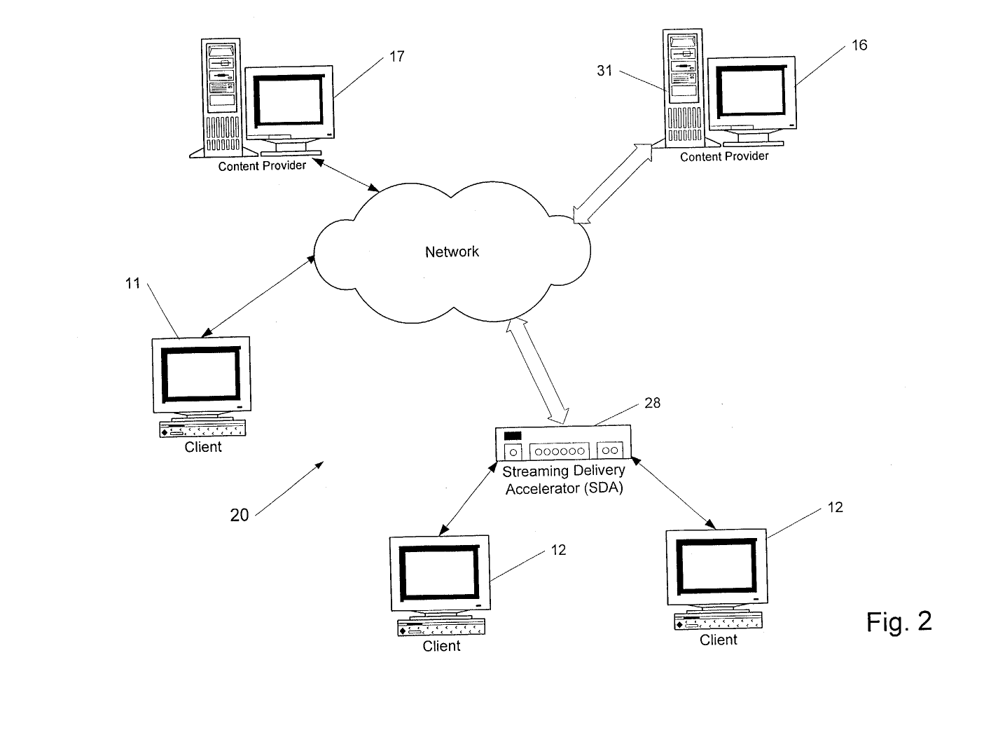

In an improved multimedia streaming solution 20 depicted in FIG. 2, the problems associated with the different transmission characteristics and pathway bandwidths are alleviated by placing a Streaming Delivery Accelerator (SDA) 28 intermediate between the content provider 16 and one or more clients 12. Although network 24 is shown as a single network, such as the Internet, network 24 can also be a local area network (LAN), an intranet or a combination thereof. Moreover, the connection between the SDA 28 and the clients 12 can also be a network connection, such as a LAN or an intranet, or even the Internet. In the streaming solution 20, the clients 12 no longer communicate directly with the content provider 16 when requesting content. Instead, client requests for streaming files from the content provider 16 are routed through and monitored by a Streaming Delivery Accelerator (SDA) 28. A service manager (not shown) interacting with software that can be connected to or embedded in the SDA system 28 can provide aggregate performance monitoring and alarm management on a network-wide basis, as well as management/configuration of system resources and protocols. Management operations can also be performed from a client 12 linked to the network 24 and running suitable software, for example, in conjunction with a Web browser.

In the exemplary streaming solution 20 depicted in FIG. 2, a client 12 requests content 31, for example a movie trailer, from a content provider 16. The client 12 has a network connection with a certain bandwidth, for example, via a modem or a T1/T3 connection. The user request is transmitted to the Streaming Delivery Accelerator (SDA) 28. The SDA 28 transmits the request for the specified file to the content provider 16. In many cases, the content 31 stored at the content provider 16, which can include video/audio files, html files, text files and the like, may not be in a format suitable for streaming directly to the client 12. For example, a file may be transmitted from the content provider 16 to the SDA 28 with a network protocol that is incompatible with the network protocol used by the client 12. Moreover, the application software at the client 12 may require interleaved video and audio, whereas the contents 31 stores video and audio as separate files. The SDA 28 should therefore be able to perform a protocol translation and/or cache and store files representing the content requested by the client in a protocol-independent (canonical) form. The term “network protocol” used in the following description is to be understood to include also “application protocols”, which represent the set of protocols corresponding to protocol layers 4 through 7 inclusive in the ISO/OSI protocol model, which is incorporated herein by reference. Accordingly, these terms can be used interchangeably. Caching is defined as storing a copy of a stream-set for later playback. Protocol-independent caching will be described below.

FIG. 3 shows in form of a schematic block diagram the architecture of an exemplary SDA 28. The SDA 28 includes a protocol translator 36 which strips the network protocol headers from the received packets and generates protocol-independent canonical payload data packets. Also incorporated is a shredder 35 that is capable of selecting from received content those packets perceived as being of use for streaming to end users. These canonical packets are then written into the SDA's cache memory 32 which can include a disk cache 31 and one or more buffer caches 33, 34. When files are streamed to clients 12, the canonical packets are retrieved from disk cache 31 and written to buffer 33 as a contiguous stream adapted to the streaming rate to the client 12. The SDA 28 includes another protocol translator 38 at the output, which appends the canonical packets with suitable network protocol headers for streaming to the client 12. The functionality of the optional second buffer cache 34 and its cooperation with the first buffer cache 33 and the disk cache 31 will be described later.

The data transmitted by the content provider 16 may be a superset of the data to be streamed to the client 12. The SDA 28 can then select from the data received from the content provider 16 those data, typically in the form of data packets, that correspond to the specific file requested by the client 12, and assemble these data into a contiguous file for streaming to the client 12 via network 24.

As indicated in FIG. 2, several clients 12 can be connected to the SDA 28 and may request the same content either simultaneously or at different times. Since SDA's 28 can be provided at various sites in a network, network traffic can be reduced substantially, if a client 12 can receive the requested file from an SDA 28 located in the vicinity of the client 12, for example, an SDA 28 located on the same intranet as the client 12, or from an SDA 28 that has little latency. A subsequent client request for the same file can then be satisfied by the SDA 28 without involvement of the content provider 16. An SDA 28 can also meet requests for multicasting, so that even if the content file was not previously cached by the SDA 28, only a single connection would be required between the SDA 28 and the content provider 16, with packet replication performed by the SDA 28.

There are at least three types of media files in use today within the streaming media server space that are used to support client requests: (1) a single rate, multi-stream file that can be composed of a video stream at a single bit-rate, an audio stream at a single bit-rate and optionally other stream types such as text, html or scripting; (2) a multi-bit-rate file that can include several video streams of differing bit-rates, audio and other stream types and can therefore service from the data stored within the file many different client requests with different transmission rates; and (3) a direct stream capture which captures only the necessary data bits to support the requested stream. The SDA is designed to handle those different streams.

The terms “Quality Caching” and the metric associated with Quality Caching (“Quality Metric”) are useful concepts for caching content. One measurement of the quality of a stream is the ratio of received packets at the SDA to the total number of packets representative of the file or the current segment thereof. Reasons for not receiving all packets, i.e., for a low quality metric, include but are not limited to: network congestion; the use of network transport that does not guarantee delivery of all packets; an end-user/client device signaling a content provider to reduce information being transferred due to the client's inability to process the received information; and/or an end-user signaling a content provider to pause, stop, rewind or fast forward the stream. The SDA can advantageously apply the quality metric of (received packets/total packets) in cases where the SDA knows up-front the total expected number of packets or if the SDA is able to detect that not all packets have been received. For example, the HTTP and MMS protocols indicate the number of expected bytes or packets that should be received. When bandwidth adaptation techniques are enabled (for example, in the MMS protocol), the SDA can also infer from missing delta-frames in a sequence of key frames of video that some packets are missing. The SDA software of the invention can hence determine whether it has received a sufficient percentage of packets to successfully serve the stream out of the cache.

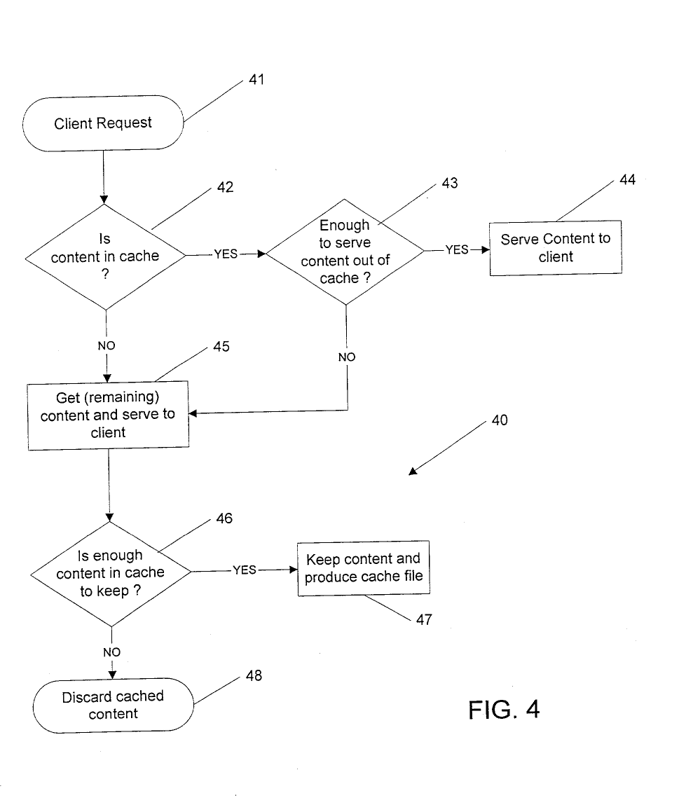

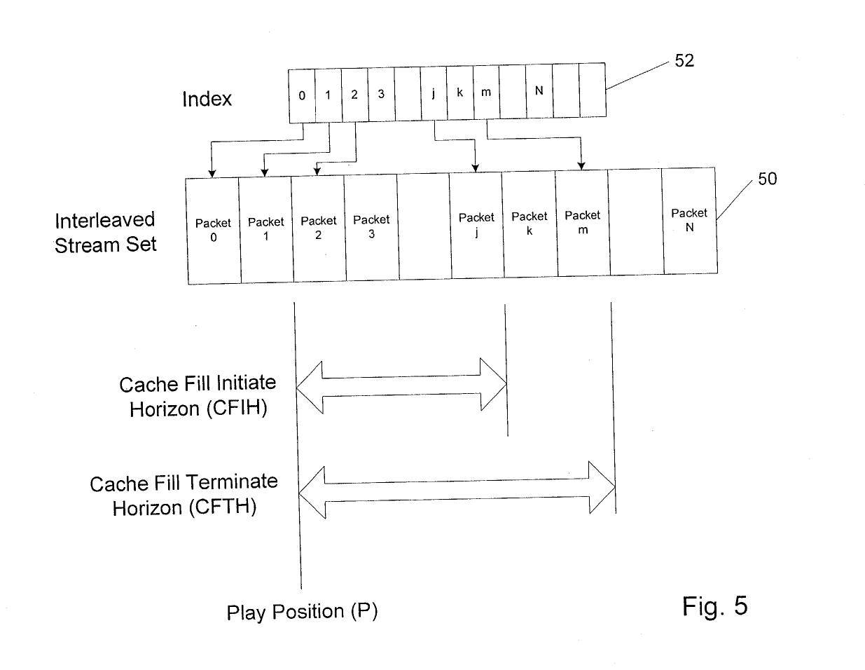

An exemplary process 40 for caching content to serve the content to a client and for retaining useful content for subsequent client streaming requests is depicted in the schematic flow diagram of FIG. 4. When a client requests content, step 41, the process 40 checks, step 42, if the content or at least part of the content, is already in the cache. If any content is detected in the cache, it is checked in step 43 if there sufficient content for streaming to the client has been cached, for example, based on the aforedescribed quality metric and defined by a quality threshold value. In other words, step 43 checks if the quality metric in the cache is greater than a preset threshold value. If enough content is present, the cached content is served to the client, step 44. Otherwise, the SDA requests and retrieves additional content, preferably the entire missing content, from the content provider to serve to the client, step 45. The actual quantity of the content to be cached in step 45 depends on the settings of the Cache fill initiate horizon (CFIH) and Cache fill terminate horizon (CFTH), which will be discussed below with reference to FIGS. 5-7.

The process 40 will then check in step 46 if a sufficient percentage of the file has been cached to make it worthwhile to keep the cached file in the cache to satisfy future streaming requests from clients. If less than a preset percentage of the file (file threshold value) was cached, the cached content is discarded, step 48. Otherwise, the cached content is kept in the cache and a cache file is produced and stored in memory. The file threshold value should ideally be 100%, in which case the stream set is not cached if: 1) any packets are missing from the stream; and/or 2) a pre-fix of the packets from the stream is not received, which would make it impossible to determine its proper position in the stream. However, a lower file threshold value may be tolerated, depending for example on the network protocol and image compression used, if dropped or frozen sections of images are acceptable. A corresponding range of values applied to the quality threshold value. However, the file threshold value and the quality threshold value need not be identical.

An efficient way to obtain the remaining content is to incrementally fill in the incomplete cache stream sets from additional data received from the content provider, but cache only the packets that were missing from the cached stream set. These packets can be requested by the SDA and extracted from the source content file at the content provider. The latter approach is referred to as iterative caching and will now be discussed.

Iterative caching is the ability to incrementally improve the quality of a cached stream. The exemplary SDA 28 may have previously cached some but not all of a streamed file during a prior request. Subsequently, another request for the same streamed file is received by the SDA. The SDA then proceeds to fetch from the content provider additional packets of the content to incrementally build up a complete set of data. It can be seen that successive requests will not degrade the quality of the subsets already residing in the cache.

Iterative caching is useful in situations where, for example: 1) there is intermittent connectivity between locations the SDA and a content provider or other content server; 2) there is low bandwidth connection between the SDA and the content provider or other content server; and 3) there is a large number of possible subsets of the content, only a few of which are useful at a particular client location. Iterative caching can be used in both streaming media caching and in network attached storage caching. Iterative caching becomes increasingly important as the space taken up by the data becomes very large.

FIGS. 5-7 illustrate an exemplary iterative cache fill process at the SDA wherein an exemplary contiguous interleaved (video/audio) stream set 50 includes packets 0, 1, 2, . . . , N, . . . that are to be streamed to a user. As seen in FIG. 5, it will be assumed that packets 0, 1, 2, j, and k already reside in the SDA's memory, and that several packets 3, . . . , k, . . . , N are missing. The packets can be indexed by packet index 52. When an end-user requests a streamed file starting at a play position P, a buffer memory is filled up to a cache fill initiate horizon (CFIH) which represents the minimum number of packets that should be present in order to obtain an initial play length of the stream with the desired quality metric. For example, all packets between packet 2 and j should be present before streaming to the user begins. With iterative caching, the cache is incrementally filled up to the cache fill initiate horizon (CFIH) by fetching from the content provider the missing packets 3, . . . , j-1. The same iterative caching process applies to filling the cache up to cache fill terminate horizon (CFTH), wherein the number of packets between the CFIH and the CFTH correspond to an assumed viewing time for a user, which can be experience-based and may hence depend on the particular viewed content. It will be understood that the packet k can represent more than a single packet, i.e., all packets necessary to maintain a contiguous streamed file.

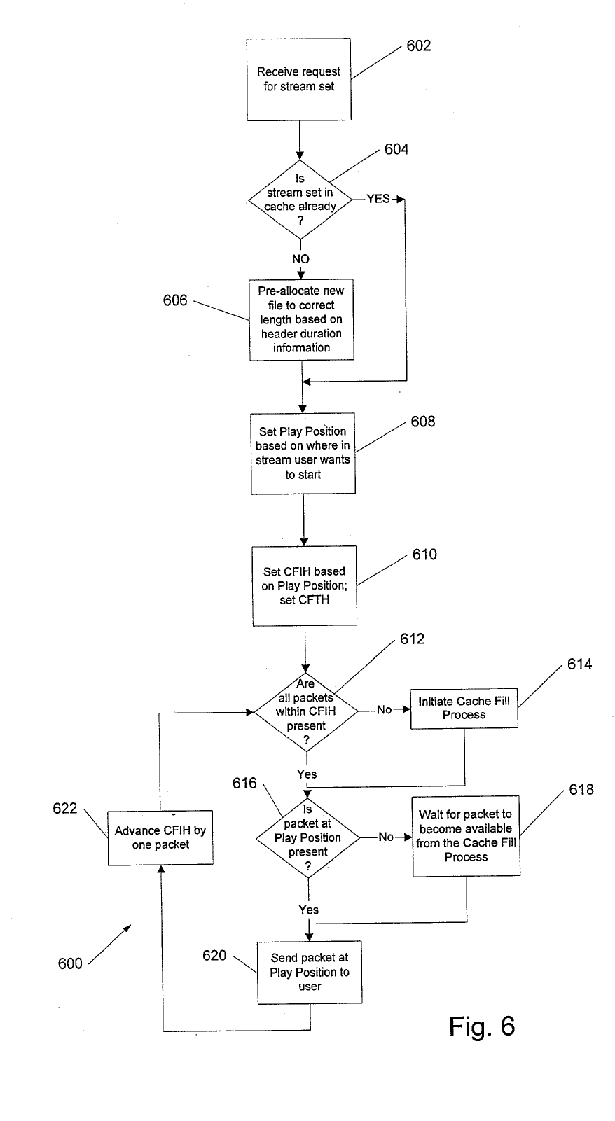

Referring now to FIG. 6, in an exemplary process 600 for iterative caching, the SDA receives a request from an end-user for streamed content with a specified bit rate and a starting play position P, step 602. The SDA first checks, step 604, if the requested stream set at the specified transmission bit rate and play position P is already in memory. If it is determined in step 604 that no part of the stream is in the cache, then a new file is allocated in the cache, for example, based on information in the file header. Conversely, if the requested set is located in memory, the play position P is set according to the user's request, step 608, and the cache fill initiate horizon (CFIH) and the cache fill terminate horizon (CFTH) are both set based on the play position P and assumed viewing preference of the user, step 610. If it is determined in step 612 that not all packets for streaming the requested file are present within the CFIH, a process for filling the cache up to the CFIH is initiated, step 614. In step 616 it is checked if the packet is present at the play position P. If the packet is present, the SDA begins to stream the file to the user, step 620, otherwise the process 600 waits for the packet to arrive, step 618. After the packet at the play position P is sent to the user, both the play position P and the CFIH are advanced by one packet, step 622, whereafter the process 600 returns to step 612. As discussed above, only those packets are cached that are not already present in the cache.

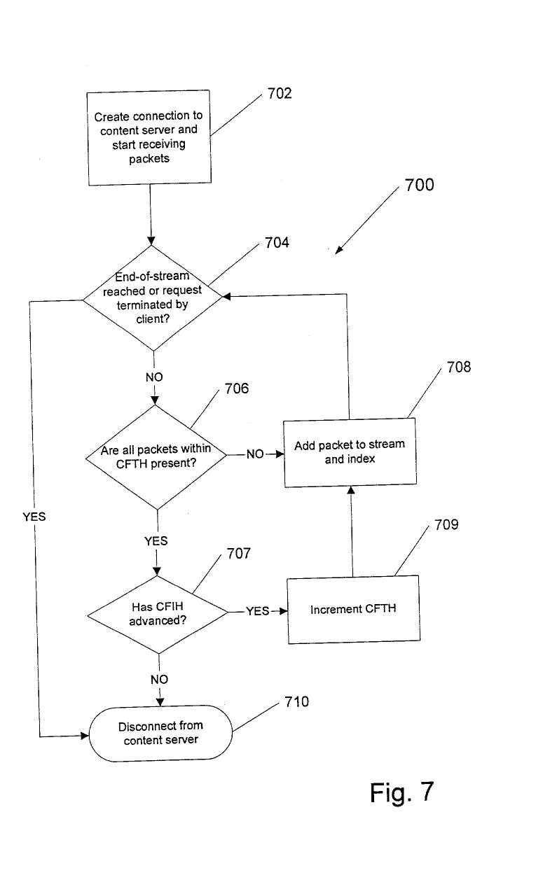

FIG. 7 illustrates the cache fill process 700 for filling the cache up to the CFTH. In response to a request from a user for streaming content, packets are sent to the SDA cache, step 702. If it is determined in step 704 that the end-of-stream (EOF) is reached or the user has terminated the streaming request, then the connection to the content server is severed, step 710. Otherwise, it is checked in step 706 if all packets for the requested stream have been cached up to the CFTH. If not all packets have been cached, a missing packet is added to the cache and the CFTH is advanced by one packet, step 709, with the process 700 returning to step 704. Conversely, if all packets up to the CFTH have been cached, the process 700 checks if the CFIH has advanced and increments the CFTH to create a “sliding window” with (CFTH−CFIH=constant) to keep an anticipated number of packets (for example, 30 seconds of streamed content) in the cache, step 709. The process 700 then continues to step 708. Otherwise, the process 700 goes to step 710 and the connection to the content server is severed as before.

The process of iterative caching described above provides an efficient means for provisioning content to be streamed to an end-user with a predictable acceptable quality, as expressed by the Quality metric. Since an SDA is designed to potentially handle large numbers of clients, in particular large numbers of concurrent real-time multimedia streams, the SDA's cache needs to be optimized for its particular resource utilization patterns, which in turn are highly dependent upon the type of content being requested and the Quality value that is desired. There are a variety of file system allocation and more particularly buffer-cache optimizations that can be used to enhance the performance of SDA's.

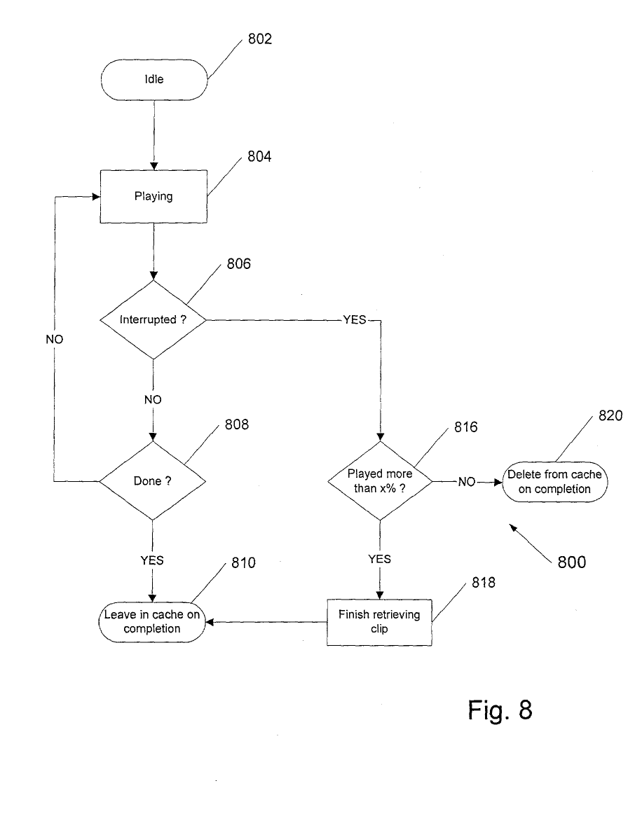

Referring now to FIG. 8, in a process 800 for managing cache content, data sets in a stream that does not represent a complete stream and may therefore not be usable for streaming to a user, may still be kept in the cache. For example, it may be beneficial to continue to cache streams from a content server that are likely to be used by another user after the present user has disconnected from the SDA. The process 800 of FIG. 8 begin in an idle state 802, with a user starting to receive streamed content, step 804. The process 800 checks in step 806 if streaming has been interrupted, for example, intentionally by the user or by another service interruption; if not, then step 808 checks if streaming of the file is complete, in which case the file can be left in the cache (at least temporarily, as will be discussed later), step 810. If streaming is not complete, as determined in step 808, then the process will return to step 804 and streaming of the file will continue. If step 806 detects that file streaming has been interrupted, the it is checked in step 816 if more than a predetermined percentage of the streamed file has been played. If less than the predetermined percentage of the streamed file was played, the cached file may not be useful for future users and will be deleted the file from the cache, step 820. If more than the predetermined percentage has been played, as determined in step 816, for example more than 50% of the total length of the file, and the stream during cache fill meets other requirements, such as the quality metric, then the SDA can continue to cache and store the stream, even though the original client is no longer interested in the stream, steps 818 and 820. This process can therefore advantageously use streams that would otherwise be discarded for streaming to other users, even when the original user did not download the entire file.

In another aspect of efficient cache management, in particular with respect to improved buffer cache ejection, a distinction is made between content (streaming content; low priority) and system data (metadata, applications, configuration files, etc.; high priority).

Bulk content represents the actual data in the multimedia files, while system data represents the metadata about the multimedia files, as well as possibly programs and data used to serve the bulk content. The system data, while representing only a small fraction of the actual content stored on the physical media and used while streaming, tends to be accessed frequently. If bulk data and system data were treated equally by the cache, system data could be emptied prematurely from the cache due to lack of memory. A subsequent failure to access system data in the buffer-cache would then prevent access to the bulk data, degrading the overall performance of the system. Accordingly, the SDA indicates to the buffer cache subsystem which data is bulk data and which is system data, and the buffer cache ejection policies of the system favor keeping system data over bulk data. The resulting reduction in buffer cache misses for system data more than compensates for the increase in retained system data. The overall system performance increases significantly due to the reduction in disk access attempts to retrieve system data that have been deleted from the buffer cache.

Efficient management of cache content also relates to limiting the amount of data stored in the cache. Data to be streamed are typically delivered from disk storage rather than from a main memory. If a file is not stored on the disk in sequential order, each disk read requiring a disk seek to locate a block of data on the disk before transmitting the next block of data. Disk seeks are time-consuming operations and increase the total disk transfer time. Without appropriate buffering of the streamed content, most streaming applications tend therefore to be governed by the seek performance of the disk storage system. The data from a file may be requested by different users with different streaming rates. Hence, a different number of bits per unit time may be requested with different storage requests. The SDA of invention hence is able to vary the size of each request based upon the bit rate of the stream being served to the client. Once the storage request has been satisfied, the data associated with the request is kept in main memory until consumed by the network connection delivering the streaming data. Varying the size of the storage request allows a trade off between expensive storage requests and the amount of main memory required. Larger individual requests require fewer operations, but consume larger amounts of memory.

Referring now back to FIG. 4, consistent and uninterrupted data delivery can be further improved by double-buffering the data read from disk 31. With double buffering, a second buffer 34 is reading data from disk 31 while the first buffer 33 is streaming the data to the client 12. However, the second buffer 34 is only allocated and reads in from disk 31 after a fixed percentage of the first buffer 33 has been consumed. Disadvantageously, double buffering tends to require more buffer cache per stream than single buffering. This situation can be alleviated to some extent by timing the allocation of buffer space in the second buffer 34 based, for example, on the estimated transmit times of the data in the first buffer 33 that have not yet been transmitted. According to this optimization, the second buffer 34 is allocated and a read from disk storage 31 into the second buffer 34 is initiated when the estimated transmission time for the amount of data left in the first buffer 33 (based on the transmission rate) is approximately equal to the time required to read data from disk 31 into the second buffer 34. With this approach, the second buffer 34 will just become ready for transmission when the first buffer 33 empties.

As mentioned above, the content file received by the SDA from the content provider can represent a superset of the file data packets requested by a client. This superset may contain multiple video streams and hence be quite large and of little use for individual clients. Due to their large size, these files are typically not kept in the SDA's memory, since they can generally be downloaded again from the content provider if the SDA receives additional requests for the file.

Instead, the SDA may “shred” the superset received from the content server into a contiguous client-specific data file for streaming to the client. In addition, the SDA may in the shredding operation assemble from the superset other contiguous files, for example, files with a different streaming bit rate. The captured stream as well as the other files can be evicted from the SDA's memory, for example, based on their frequency of use or other criteria.

Each of the “shredded” data files contains an individual component stream with typically an interleaved audio/video stream of appropriate bit rate to be transmitted to a user. The SDA can dynamically interleave the component streams at the time the data files are placed on the storage medium of the SDA, which reduces processing delays on playback. The process of creating streams pre-processed for later playback is called Stream Shredding. Stream Shredding may be performed either statically before a client request has been issued, or dynamically at the time of a user request. Static Stream Shredding is initiated on the SDA by an administrator request to pre-populate streams on the SDA. This request will cause the creation of data files representing one, several or all possible combinations of the component streams. Stream shredding can be performed when the first user requests a stream combination that does not already exist on the SDA. At the time the stream is collected and shredded for delivery to the client, it is also saved on the storage medium for subsequent use. This shredded stream is then used for all subsequent client requests for the same stream combination. As a result, each shredded stream file advantageous contains essentially only those data required by a particular common session, with the client receiving a subset of the original data, differentiated, for example, by available bandwidth as before, language preference, or other static or dynamic characteristic of that particular session. This optimization can result in significant performance gains, at a tolerable cost of redundant storage.

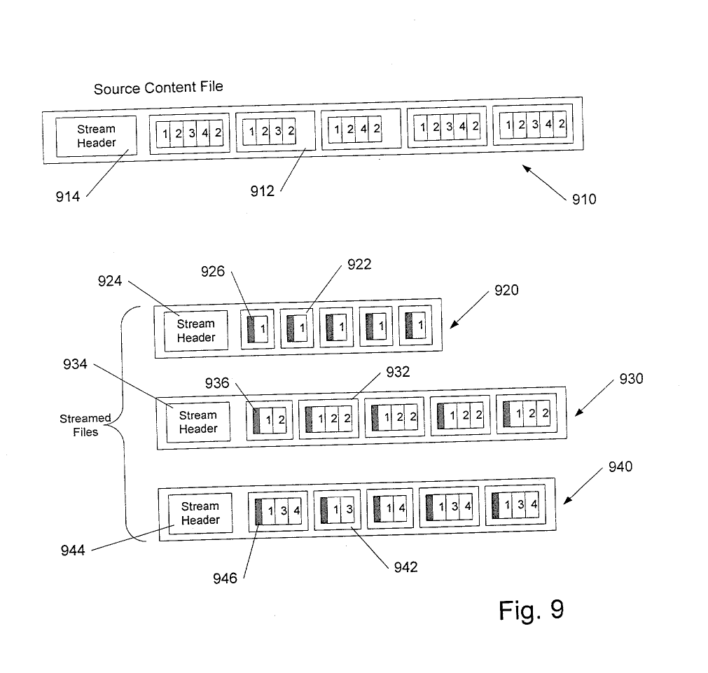

As illustrated in FIG. 9, in an exemplary shredding process, the SDA receives a source content file 910 from a content provider and “shreds” the source content file 910 into a number of exemplary contiguous files 920, 930, 940 that are available for streaming to end-users and have different file characteristics, such as different bit rates, different language audio tracks, different video resolution and the like. The original exemplary content file 910 can have a stream header 914 and presentation units 912 containing different exemplary content file packets 1, 2, 3, and 4. As seen from FIG. 9, for the particular piece of content, the streamed files 920, 930, 940 represent contiguous subsets of the content file 910. The streamed files 920, 930, 940 can also include stream headers 924, 934, 944 representing, for example, different network protocols for connection to the end users, and respective presentation units 922, 932, 942 with network headers 926, 936, 946 and payload data packets 1, 2, 3, 4. These subsets can be rated, as mentioned above, in terms of their streaming characteristic, in particular their streaming bit rate.

The respective presentation units 922, 932, 942 and/or payload data packets 1, 2, 3, 4 of the streamed files 920, 930, 940 are typically arranged in the cache in a particular order which reflects the transmission order to the client. One particular transmission order could be a time-sequential arrangement.

Caches are of finite size and the number of potentially cacheable objects is typically orders of magnitude larger then the cache size. Processes that can more effectively manage the cache space translate directly into operational benefits. For example, the cache should advantageously be able to evict content from the cache to make room for new content that needs to be cached. Therefore, one cache operation is the removal of less frequently accessed items (or files) from the cache space. For example, the popularity of videos has been shown to follow a Zapf-distribution with a skew factor of 0.271, which means most of the demand (80%) is for a few quite popular video clips. To quantify this result for the SDA, the SDA tracks and controls information for each file served by the SDA, for example, file attributes such as the streaming protocol used (e.g., MMSU, RTSP, HTTP, and the like), which streams within a file are selected, streaming bit rates, stream characteristics (e.g., audio, video, etc.); and length of streams. Recording the attributes enables the illustrative SDA to develop a better picture of what clients are likely to request in future operations. For example, the SDA can record how often a 100 Kb/s stream is selected versus other bit-rates. With this information, the SDA can decide which streams to remove from the cache.

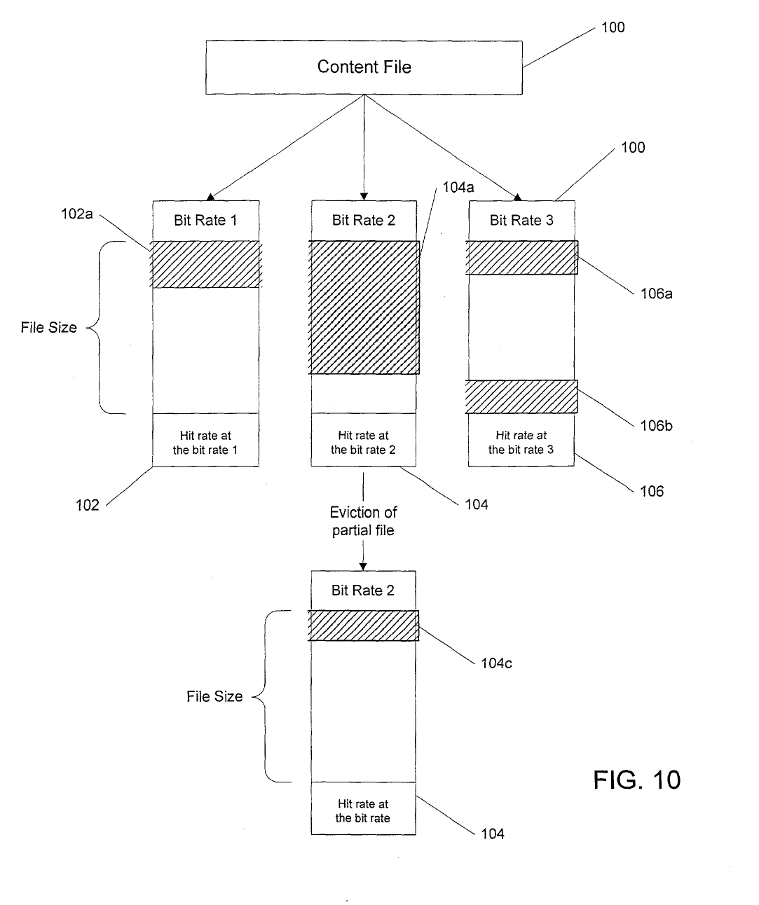

Referring now to FIG. 10, a number of files 102, 104, 106 were shredded from a content file. Each file 102, 104, 106 is adapted for a specific bit rate (n=1, 2, 3) and characterized by a “hit rate” which is updated periodically. Initially, an entire file may have been cached. After a period of time, content of the cache is purged to make room in the cache. According to an embodiment of the invention, however, instead of the entire streamed file, only a portion of a file 102, 104, 106 is evicted from the cache. As depicted in FIG. 10, file portion 102a of file 102, file portion 104a of file 104, and file portions 106a, 106b of file 106 remain in the cache. After a certain time period has passed with little interest in the file 104 past the beginning portion of the file, the intermediate portion will also be purged from the cache, with only the beginning portion 104c remaining in the cache for future streaming. The criteria used by the SDA for cache eviction will now be described.

For example, the SDA can employ a “least frequently used” algorithm. Thus, if clients request 100 Kb/s streams more often than streams with other streaming rates, then the 100 Kb/s media streams will tend to remain in the SDA longer. In this fashion, the illustrative SDA tends to accumulate media streams that more closely resemble the types of requests that have been seen before, and thus are more likely to be seen in the future.

Alternatively or in addition, the SDA can employ a “least recently used” or “age-based” algorithm for purging outdated media streams from the cache which are expected to be used less and less frequently. The SDA may also define an age horizon beyond which all cached items are deemed to have the same age. For items beyond the horizon, but also for items within the horizon, the SDA may employ the “least recently used” algorithm to make a decision as to which items to purge. The cache may also evict from the least requested streams first those files that have the lowest streaming rates.

Cache retention can also be adapted to the expected viewer habits. For example, shorter files that are more likely to be streamed to a user, can remain in the cache longer than longer files. Also, as described above with reference to file 204, the beginning portion of a file can remain in the cache longer than the middle or end portion of the file since many users may only be interested in a “snapshot” of the file and will play the streamed file for a short duration from the beginning. If necessary, the content removed from the cache can be recached from the content provider. The cache eviction process hence treats each shredded file in the cache as a separately manageable and evictable entity. Moreover, partial components of files and shredded files can be evicted, leaving more popular segments of the files in the cache.

It will be understood that the data sets in all embodiments described herein can be composed of video and audio, text, html files, wherein these data can be combined in the transmitted packets to ensure synchronization.

A barrier to achieving high throughput is the high cost of copying data in the SDA relative to the cost of processing that data. The basic shredding operation described above would require copying the actual data for each subset from the original stream. Therefore, in order to exploit the throughput potential of the SDA, the number of copies between content provider and user must be kept to a minimum. One opportunity to improve performance is to eliminate copying by performing a lookup to locate the cached data and to provide addressability to the cached data, for example, by providing a pointer to the data. This requires mapping the cached data into host address space. Protocol processing may be performed and protocol headers inserted before the cache is instructed to transmit the packet. This approach is particularly suited for continuous media applications, such as streaming, which involve the transfer of data between the SDA and one or more users without requiring the manipulation of that data. This improves throughput and efficiency of the SDA.

A memory-mapped interface is required to make copy elimination possible. The zero-copy feature has a direct impact on cache performance. A feature of the zero-copy model presented here is that network data is not brought into the cache unless and until it is explicitly copied by the processor, which provides a number of benefits. Firstly, the level of cache residency seen by the rest of the system increases if network data does not enter the cache. Secondly, incoming network data is only brought into the cache if and when the application consumes the data (i.e. as late as possible). This maximizes cache residency by eliminating the potential for context switches between the data being brought into the cache (by the network subsystem) and the data being consumed by the application. Moreover, the performance penalty incurred by making non-cacheable accesses to memory is reduced with protocols that touch only part of a packet (e.g. the header) rather than the entire packet. Such protocols generally sacrifice error detection (by eliminating the checksum, for example). However, the SDA of the invention pre-computes checksums and stores these checksums, as described below. Since in “zero-copy” mode the data remain unchanged, the checksums also remain valid and do not have to be recomputed.

To further increase the streaming efficiency, the SDA can precompute correction information, such checksums of packets of payload data, when the data are cached, or alternatively can use the checksums transmitted by the content provider with the content file, and store the checksums in memory. The checksums relate to the canonical form of the content stored in the SDA and therefore typically does not include packet header, addresses, etc. In other words, payload data packets that are identical except for the header have identical checksums. With this approach, there is no need to recompute the checksums when streaming the file to the end user. In this way, the SDA of the invention avoids the delay associated with recalculating the checksums each time the SDA plays back the stream and can use the advantageous features associated by “zero-copy” and “zero-touch” transfer of the streamed data through the SDA. Since each protocol supported by the SDA for transmitting content to/from the SDA is able to convert to/from the canonical form stored in the SDA, checksums computed for different streaming protocols, such as TCP, UDP and other proprietary streaming network protocols, can later be used with other protocols when streaming from the cache. The checksums used by TCP, UDP and many streaming protocols can therefore be easily updated on the fly to reflect partial updates only to the data associated with a respective checksum. Typically, data packets for streaming content are already broken into packet-sized units so the check sums of entire packet-sized units of data may be precomputed when the streaming data is written to storage.

The checksum for each fragment can be maintained independently, so the server can reuse fragments without recomputing the checksum of each fragment. This allows portions of a response to be cached and check-summed independently. When constructing a response to a user request, the server only needs to pull together previously cached portions and add the corresponding checksums. The zero-copy feature can also eliminate additional copying into the cache, as described above.

Since typically several clients can request the same content using identical streaming protocols, the transmitted pre-computed checksums are an efficient means for detecting, and optionally correcting, corrupted packets at the end-user site. However, the network protocols used between the SDA and content provider may or may not compensate for lost or corrupted data. For performance and scalability reasons, although not all errors are corrected, errors are typically detected.

Another aspect of efficient management of cache content relates to the efficient streaming of content independent of the streaming protocol. Different protocols can be used to deliver the same piece of content. Some protocols are optimized use with a local area network (LAN) while other protocols are optimized for delivery through firewalls. Once content is cached, protocols must be used to authenticate access to the content and to send usage information about what content has been delivered. Traditionally, caches have tied the protocol a client used to request content to the protocol the cache used to retrieve, authenticate and log access to the content.

Protocol-independent caching is a process whereby the protocol used by a client to access content from cache is separated from the protocol used to fetch the content from the content provider into the cache. This involves translating content as well as authentication and usage information from a protocol-specific form into a protocol-independent (canonical) form when content is acquired; and then translating the protocol independent-form back into a protocol-dependent form when a user makes a request to the cache from streaming. For example, in one embodiment, Windows Media Format received via the MMST, SSH/SCP and FTP protocols can thereby be streamed, authenticated and logged to clients using MMSU, MMST, or MMSH protocols. Conversely, Real Media® content received via HTTP, SSH/SCP and FTP protocols can then be streamed, authenticated and logged to clients using different RTSP/RTP/RDT and PNA protocols.

The servers of content providers as well as the SDA, as mentioned above, typically include storage subsystems having persistent memory, such as disk and/or tape drives, and short-term memory, such as RAM, for storing the content that will be served and/or replicated. Efficient handling of client requests for streaming multimedia files requires not only an optimized cache, but also an optimization of the storage subsystem and, more particularly, the data structure of these files.

Conventional file systems perform disk-block allocation using fixed-size allocation units, regardless of the type of content being stored in the file. These allocation units tend to be relatively small, often on the order of 4 KB, which is adequate for many computer application files and data files. However, these allocation units are significantly smaller than the size of multimedia files providing streamed content. Accordingly, finding the correct blocks of a multimedia file could require a large number of disk “seek” operations, which can reduce throughput and degrade disk performance. Optimizing the allocation units for multimedia files can therefore be expected to result in substantial performance gains.

Streaming applications can be written to read largely deterministic sized portions as they are being streamed. An optimum size of the allocation units can be determined by analyzing the bit rate of the streamed files being stored on the disk. Optimizing the storage subsystem to allocate space in this manner eliminates or at least substantially reduces any intra-file-read seeks, while avoiding the storage inefficiencies of storing all files contiguously.

The allocation units for multimedia files can be optimized, for example, by dynamically building variable size allocation units so that the streamed files can be read at the same disk request frequency (e.g., number of seeks per second), regardless of the bit-rate of the stream. It will be understood that due to potential non-linear characteristics of the memory subsystems (such as virtual or physical page size, map region allocation performance, etc.) and for ease of implementation, there may be a range of variable size allocation units for various bit-rates. However, the ability to read large portions of files adapted for higher bit-rates and having larger disk allocation sizes can still improve disk performance even if this approach requires increased memory storage for the read-ahead portion of low bit-rate streams. File allocation management can be conventional and can include a storage metadata layout, frequently also referred to as file allocation table.

To accommodate variable size allocation units, file allocations can be made in a cascading fashion wherein as the file size grows, the allocation size grows as well. This can be accomplished by organizing the metadata structure in form of an inode. An inode is a data structure holding information about files. There is an inode for each file and a file is uniquely identified by the file system on which it resides and its inode number on that system. The inode structure provides embedded pointers to data blocks, and a pointer to an indirect block, which itself can contain more pointers to data blocks of different size, and possibly a pointer to a double-indirect block, which once more can contain pointers to more indirect blocks, and so on.

Referring now to FIG. 11, in an embodiment particularly suited for streaming applications, files are allocated in a cascading fashion wherein the allocation size can increase with bit rate. For example, the allocation units 112 (indicating a direct block), 113 (indicating an indirect block), and 114 (indicating a double-indirect block) can be laid out on a disk storage medium, each with a conventional (small) block size. However, whereas some of the blocks can be direct blocks 112 that include conventional small data blocks 115, which may be suitable for low bit rate streaming, for example, for streaming to a 56 kB modem, other blocks can be indirect blocks 113, each of which can in turn point to direct blocks 112′ containing larger data blocks 116 adapted for streaming at a higher bit rate. Likewise, double indirect blocks 114 can each point to differently sized indirect blocks 117 which each include pointers to corresponding direct blocks 112″, 112′″containing again larger data blocks 116 adapted for streaming at an even higher bit rate. The large data blocks 116 addressed by the indirect blocks can all be contiguous. Alternatively, the double-indirect blocks 114 can point directly to extra-large data blocks (not shown), in the same manner as the indirect blocks 113 point to the large data blocks, since the start and length of the large and extra-large data block is the only information needed for streaming. In either of these schemes, one may predefine the size of the small and large (or extra-large) data blocks, as well as the number of pointers, to optimize the allocation patterns for files depending on various bit rates.

The aforedescribed allocation scheme can also optimize the storage-efficiency/performance balance for files stored on the SDA, which includes small files (e.g. streaming content meta-information) and large files (e.g. streaming content data).

While the invention has been disclosed in connection with the preferred embodiments shown and described in detail, various modifications and improvements thereon will become readily apparent to those skilled in the art. Accordingly, the spirit and scope of the present invention is to be limited only by the following claims.

What is claimed is:

1. A method of allocating data blocks for streaming a file, comprising:
determining a data transfer characteristic for streaming the file;
selecting a block size as a function of the data transfer characteristic;
allocating data blocks having a block size on a persistent storage medium, said block size related to the data transfer characteristic;
storing said file as the data blocks on the persistent storage medium;
transferring the data blocks from the persistent storage medium into a first buffer memory, with the data blocks in the first buffer memory having the block size;
determining an actual bit rate to a user;
allocating a second buffer memory to receive from the persistent storage medium additional data blocks based on the actual bit rate to a user, with the data blocks in the second buffer memory having the block size; and
transmitting the additional data blocks from the persistent storage medium to the second buffer memory when an estimated transmit time for streaming a portion of the data blocks remaining in the first buffer to a user is approximately equal to a time required to transfer the additional data blocks from the persistent storage medium into the second buffer.

2. The method of claim 1, wherein the transfer characteristic is a maximum bit rate for the file.

3. The method of claim 2, wherein allocating data blocks on the persistent storage medium includes
defining data blocks that have at least two block types;
associating a first block type with a direct block comprising the data blocks and associating a second block type with an indirect block comprising a pointer to a plurality of other direct blocks or of additional indirect blocks; and
storing on the persistent storage medium a contiguous sequence of at least the blocks that are addressed by the pointer.

4. The method of claim 3, wherein the block size of the additional direct blocks is greater than the block size of at least one of the indirect blocks and the blocks of the first block type.

5. Device for allocating data blocks for streaming a file, the device comprising:
a persistent storage medium storing the data blocks of the file, said data blocks having a block size allocated related to a data transfer characteristic;
a first buffer memory that receives the data blocks from the persistent storage medium, said data blocks in the first buffer memory having the block size;
a second buffer memory that receives additional data blocks from the persistent storage medium, said data blocks in the second buffer memory having the block size,
wherein the additional data are received in the second buffer memory when an estimated transmit time for streaming a portion of the data blocks remaining in the first buffer to a user is approximately equal to a time required to transfer the additional data blocks from the persistent storage medium into the second buffer.

6. The device of claim 5, wherein the transfer characteristic is a maximum bit rate for the file.

7. The device of claim 5, wherein the persistent storage medium is a disk storage medium.

8. The device of claim 5, wherein the first buffer memory and the second buffer memory are volatile memory devices.

9. The device of claim 8, wherein the volatile memory devices comprise random access memory (RAM).

10. The device of claim 5, wherein the block size includes a plurality of block sizes, said block sizes organized in an inode structure and determined by at least one of a maximum streaming rate of the file and a maximum seek time for the data blocks on the persistent storage medium.

11. Streaming delivery accelerator (SDA) for efficiently streaming a file, comprising:
at least one input channel that receives a content file from a content provider;
at least one output channel with a predetermined streaming characteristic for streaming a cache file to a user;
a persistent storage medium that caches data blocks of the content file and stores the data blocks as the cache file, said data blocks having a block size allocated related to a data transfer characteristic;
a first buffer memory that receives the data blocks from the persistent storage medium, said data blocks in the first buffer memory having the block size;
a second buffer memory that receives additional data blocks from the persistent storage medium, said data blocks in the second buffer memory having the block size,
wherein the additional data are received in the second buffer memory when an estimated transmit time for streaming a portion of the data blocks remaining in the first buffer to the user is approximately equal to a time required to transfer the additional data blocks from the persistent storage medium into the second buffer.

12. The SDA of claim 11, wherein the persistent storage medium is a disk storage medium.

13. The SDA of claim 11, wherein the first buffer memory and the second buffer memory are volatile memory devices.

14. The SDA of claim 11, wherein the streaming characteristic includes a data transmission rate to the user.

15. The SDA of claim 11, wherein the at least one input channel operates using a first network protocol, and the at least one output channel operates using a second network protocol that is different from the first network protocol.

16. The SDA of claim 11, wherein the at least one input channel operates using a first network protocol, and the at least one output channel operates using a second network protocol that is identical to the first network protocol.

17. The SDA of claim 11, wherein the cache file stored in the persistent medium device is stored as a canonical file.

18. The SDA of claim 11, wherein data blocks of the stored cache file include checksum representative of payload data.

19. The SDA of claim 11, wherein the data blocks include a checksum, and wherein the checksum received with the content file is used for computing a checksum of the cache file streamed to the user.
